(19) United States
(12) Patent Application Publication
(10) Pub. No.: US 2003/0132307 A1
(43) Pub. Date: Jul. 17, 2003

(54) Beverage straw with thermally smoothed tips

(76) Inventor: Joshua Ji Park, Northridge, CA (US)

Correspondence Address: Eugene Oak, Ph.D., J.D. Patent Attorney, 610 S. Van Ness Ave., Los Angeles, CA, 90005, US

(21) Appl. No.: 10/045,707

(22) Filed: Jan. 15, 2002

(51) Int. Cl. A47G 21/18; A61J 15/00

(52) U.S. Cl. 239/33; 239/24; 239/12

(57) ABSTRACT

Both tips of a plastic straw are thermally treated to smooth the sharp edges of the fresh cut tip ends. The straw of this invention protects human from being hurt by the sharp tip edges of a conventional beverage straw. After the cutting step in extrusion process of polyolefin tubes, both tip ends of the tubes from the cutter are contacted with hot and smooth surfaces of, including but not limited to, a metal and a ceramic tile surface at a temperature of at least 50° C. for shorter than 1 minute rendering smoothed tip-ends.

The present invention relates to a beverage straw having smooth tip-end edge for protection of human from being hurt by the sharp end edges of a conventional beverage straw.

### BACKGROUND OF THE INVENTION

1. Field of Invention

The present invention relates to a beverage straw having smooth tip-end edge for protection of human from being hurt by the sharp end edge of conventional beverage straw. Heat treatment of the tip-ends of a fresh cut straws renders smooth tip-end's edges.

2. Description of the Prior Art

U.S. Pat. No. 4,171,401 to Legrix et al. teaches methods of manufacturing the artificial straw from thermoplastic alimentary polymer chips. The process for manufacturing artificial straw consists of extrusion, cooling, shaping, aspirating, cutting and collecting. Blade was used for cutting.

U.S. Pat. No. 4,317,352 to Michel illustrates a cutting device for a direct extrusion press shearing the residue remaining in the press cylinder after extrusion of the useful part of the billet to separate the residue from the extruded product. The device is comprised of a plane blade that is displaceable in a direction perpendicular to the extrusion axis between operative and inoperative positions and is guided in its displacement by guide means and displaced by drive means both of which are mounted on the slide block of the press. Most of today's industrial extrusion process is equipped with such direct cutter.

U.S. Pat. No. 5,495,972 to Nishimura, et al. introduced a method and apparatus for cutting flat tubes into unit pieces, which includes moving in a transverse direction rotating disc cutters with knife edges so as to cut the upper and lower walls of a flat tube to form a pair of cutting grooves and fixing in the vertical direction a length of the flat tube downstream of the cutting grooves to break it off at the cutting grooves, thereby providing a unit piece of a predetermined length.

All prior arts utilize sharp edge blades to cut the hollow plastic tubes into shorter ones like beverage straws. The edges of the tips of straw made by the manufacturing processes of the prior art are as sharp as the sharpness of blades used. This sharp tip-end edge is a potential hazardous to a human.

### SUMMARY OF THE INVENTION

The purpose of this invention is to provide a straw, both tip-end edges of which are smooth to protect human from being hurt by the sharp tip-end edge of conventional beverage straw. Conventional straws from cutting process are treated with heat to smooth the sharp edge of the fresh cut tip-ends. The straw of this invention is treated with heat at both tips to render smooth tip-ends. The straw of this invention is treated after the cutting step of the extruded polyolefin tubes. Both tip-ends of the straw of this invention are contacted with hot smooth surfaces made of, including but not limited to, a metal and a ceramic tile surface at a temperature above at least 50° C. for shorter than 1 minute rendering smoothed tip-end.

### BRIEF DESCRTIPTION OF THE DRAWINGS

FIG. 1 is a perspective view of a prior art beverage straw.

FIG. 2 is an enlarged side view of tip-end of straw of FIG. 1.

FIG. 3 is a perspective view of the tip edge of a straw of this invention.

FIG. 4 is an enlarged side view of tip-end of a straw of FIG. 3.

### DETAILED DESCRIPTION OF THE PREFERRED EMBODIMENTS

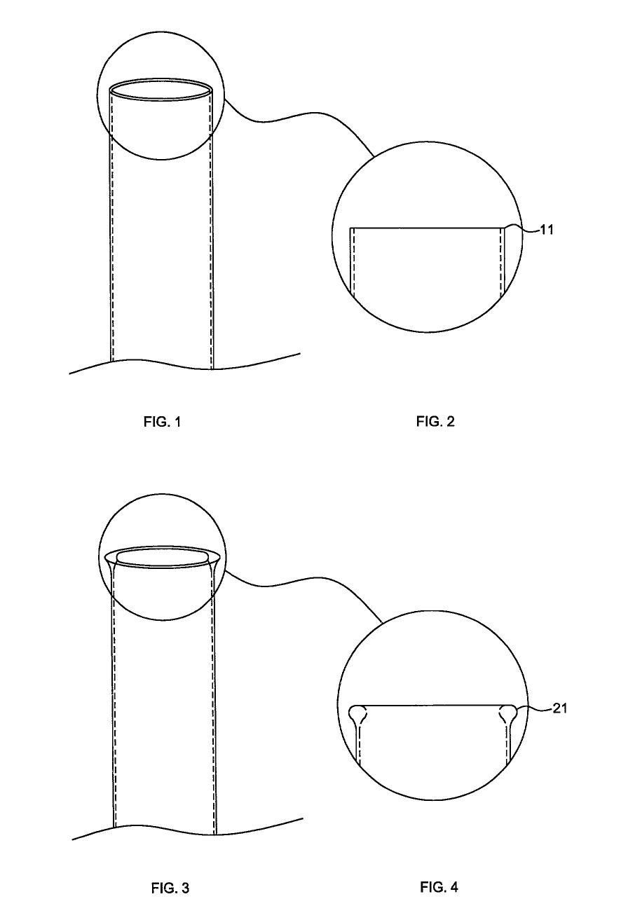

FIG. 1 is the perspective view of the tip edge of a conventional straw. As shown in FIG. 1, a prior art beverage straw has straight hollow plastic tube. The edge (11) of the tip-end of the prior art straws is sharp as shown in FIG. 2.

When a tip end of a conventional straw is contacted on a hot smooth surface of metal, the tip-end's inner radius is reduced and outer radius is increased slightly as shown in FIG. 3. Subsquently, the edge (21) of the tip-end of the straw of this invention becomes thicker, round and smooth as in FIG. 4.

The temperature of hot smooth surface to be contacted with conventional beverage straw is higher than the glass transition temperature of the material of construction of a straw and lower than 5° C. above the melting temperature of the material of construction of the straw.

Contacting period of the straw and hot surface depends on the temperature of the hot surface. Longer contacting time is needed for lower hot surface temperature.

The best mode of rendering smooth tip-end edge on a conventional beverage straw is at a surface temperature of 90° C. and contacting period shorter than 1 second.

What is claimed is:

1. Beverage straw tip edges are heat treated by contacting with smooth surfaces of metal and ceramic at a temperature of 90° C. for 1 second, to produce safe rounded tip edges.

2. The heat treatment temperature in claim 1 is from 50° C. to 130° C.

3. The contacting time in claim 1 is from 0.1 seconds to 5 minutes.
